(19) United States
(12) Patent Application Publication
(10) Pub. No.: US 2006/0191268 A1
(43) Pub. Date: Aug. 31, 2006

(54) METHOD AND APPARATUS FOR COOLING GAS TURBINE FUEL NOZZLES

(75) Inventors: Stanley Kevin Widener, Greenville, SC (US); Thomas Edward Johnson, Greer, SC (US)

Correspondence Address: CANTOR COLBURN, LLP, 55 GRIFFIN ROAD SOUTH, BLOOMFIELD, CT, 06002, US

(73) Assignee: GENERAL ELECTRIC COMPANY, Schenectady, NY (US)

(21) Appl. No.: 10/906,588

(22) Filed: Feb. 25, 2005

(51) Int. Cl. F02C 7/22

(52) U.S. Cl. 60/772; 60/740

(57) ABSTRACT

A method and apparatus for a nozzle of a gas turbine engine is disclosed that facilitates extending a useful life of the nozzle. The method and apparatus include an impingement baffle plate disposed at a back side of a diffusion tip of the nozzle. The method and apparatus includes the impingement baffle plate formed with an array of orifices creating jets for fuel or purge air to impinge on the diffusion tip. In this manner, cooling via convection through diffusion orifices in the diffusion tip is preserved, and cooling is made more robust.

### BACKGROUND OF THE INVENTION

This invention relates to gas turbine combustion systems and, specifically, to a new gaseous fuel nozzle tip design which is intended to provide impingement cooling to a back side thereof in addition to cooling with fluid flow through diffusion orifices of the nozzle tip.

A gas turbine combustor is essentially a device used for mixing fuel and air, and burning the resulting mixture. Typically, a heavy duty gas turbine compressor pressurizes inlet air which is then turned in direction or reverse flowed to the combustor where it is used to cool the combustor and also to provide air to the combustion process. The assignee of this invention utilizes multiple combustion chamber assemblies in its heavy duty gas turbines to achieve reliable and efficient turbine operation. Each combustion chamber assembly typically comprises a cylindrical combustor liner, a fuel injection system, and a transition piece that guides the flow of the hot gas from the combustor liner to the inlet of the turbine section. Gas turbines for which the present fuel nozzle design is to be utilized may include one combustor or several combustors arranged in a circular array about the turbine rotor axis.

Traditional gas turbine combustors use diffusion (i.e., non-premixed) combustion in which fuel and air enter the combustion flame zone separately and mix as they burn. The process of mixing and burning produces flame temperatures exceeding 3900° F. Because diatomic nitrogen rapidly disassociates and oxidizes at temperatures exceeding about 3000° F. (about 1650° C.), the high temperatures of diffusion combustion result in relatively high NOx emissions. One approach to reducing NOx emissions has been to premix the maximum possible amount of compressor air with fuel. The resulting lean premixed combustion produces cooler flame temperatures and thus lower NOx emissions. The assignee of this invention has called such systems “dry low NOx”, or “DLN” systems. Although lean premixed combustion is cooler than diffusion combustion, the flame temperature is still too hot for conventional combustor components to withstand without cooling.

Combustion systems are typically cooled using compressor discharge air. In DLN combustion systems, this cooling is preferably supplied as cold side convection rather than film cooling, as cold side convection preserves the maximum amount of cooling air to be premixed with fuel and subsequently burned. Such cooling must be performed within the requirements of thermal gradients and pressure loss.

Premixed combustion can typically be sustained only at moderate or high turbine loads, as the lighter load conditions result in premixed mixtures too lean to burn. One solution to this problem is to provide fuel nozzles for DLN combustors with multiple operating modes including a diffusion mode for low load operation, a premixed mode for high load operation, and an intermediate mode incorporating both diffusion and premixed combustion. For the diffusion mode, fuel is injected in close proximity to the flame near the tip of the nozzle. The portion of the nozzle that injects the diffusion fuel is called the “diffusion tip.”

With respect to a DLN diffusion tip exposed to high temperature combustion gases and therefore subject to thermal stress, one current practice is to cool the diffusion tip by one or a combination of the following methods. One includes convection cooling of the tip with fuel or purge air through diffusion orifices of the tip. Another includes cooling the tip using a curtain of compressor discharge air at the tip.

The first method is not very effective at cooling the tip and is risky during periods when there is neither flow of fuel nor air through the diffusion tip, such as during fuel transfer transients. The latter method is effective at cooling the tip, but is costly and difficult due to the requirement of an additional fluid path for compressor discharge air to pass through the nozzle to the diffusion tip. This difficulty is particularly acute for smaller gas turbines where the available space for parallel fluid passages in the nozzle tip is very limited.

Accordingly, there is a need for a system and method for adequately cooling a tip of a fuel nozzle for a DLN combustion system while eliminating a requirement for an additional fluid path for compressor discharge air to pass therethrough.

### BRIEF DESCRIPTION OF THE INVENTION

The above discussed and other drawbacks and deficiencies are overcome or alleviated in an exemplary embodiment by a fuel nozzle assembly configured to cool the tip of the diffusion nozzle via a combination of convection cooling through the diffusion orifices and impingement cooling on the back side of the diffusion tip.

In accordance with one embodiment of the present invention, there is provided a method of preventing thermal distress in a gas fuel nozzle used in a gas turbine having a compressor, a combustor, and a turbine. The method includes: disposing an impingement baffle plate upstream of diffusion orifices defining a nozzle tip, the baffle plate having an array of small orifices; and creating jets of cooling fluid impinging on the nozzle tip via the impingement baffle plate when at least one of fuel and air flow through the array of small orifices.

In another embodiment, a method for cooling a fuel nozzle tip is disclosed. The method includes: providing a gas fuel nozzle including an outer peripheral wall; an air flow passage defined within the outer wall and extending at least part circumferentially thereof; and a central gas fuel flow passage; securing a nozzle tip to the outer peripheral wall at a distal end thereof to substantially block the central gas flow passage, the nozzle tip including diffusion orifices defined about a periphery thereof; and disposing an impingement baffle plate upstream of diffusion orifices defining the nozzle tip, the baffle plate having an array of small orifices creating jets of fluid impinging on a back side of the nozzle tip. The cooling of the nozzle tip is accomplished with the same fluid flowing through the impingement baffle plate and the diffusion orifices eliminating an additional flow path to the nozzle tip.

In accordance with another embodiment of the present invention, there is provided a fuel nozzle for a gas turbine including: a nozzle body terminating at a tip portion; a nozzle tip defining the tip portion, the nozzle tip defined by a plurality of diffusion orifices about a periphery thereof; and an impingement baffle plate upstream of the diffusion orifices, the baffle plate having an array of small orifices creating jets of cooling fluid impinging on a back side of the nozzle tip via the impingement baffle plate when at least one of fuel and air flow through the array of small orifices.

The above-discussed and other features and advantages of the present invention will be appreciated and understood by those skilled in the art from the following detailed description and drawings.

### BRIEF DESCRIPTION OF THE DRAWINGS

Referring now to the drawings wherein like elements are numbered alike in the several Figures:

FIG. 1 is a partial cross section of a known gas turbine combustor;

FIG. 2 is a simplified and partially schematic cross-section of a known gas turbine gas-only nozzle for use with the present invention;

FIG. 3 is a simplified and partially schematic cross-section of a known gas turbine dual-fuel nozzle;

FIG. 4 shows a cross-sectional view of a DLN diffusion nozzle having an impingement baffle plate disposed in a center passage thereof in accordance with an exemplary embodiment of the present invention;

FIG. 5 shows an enlarged partial cross-sectional view of FIG. 4 illustrating a side view the impingement baffle plate disposed on a back side of a diffusion nozzle tip in accordance with an exemplary embodiment of the present invention; and

FIG. 6 is an end view of the impingement baffle plate shown in FIG. 5 in accordance with an exemplary embodiment of the present invention.

### DETAILED DESCRIPTION OF THE INVENTION

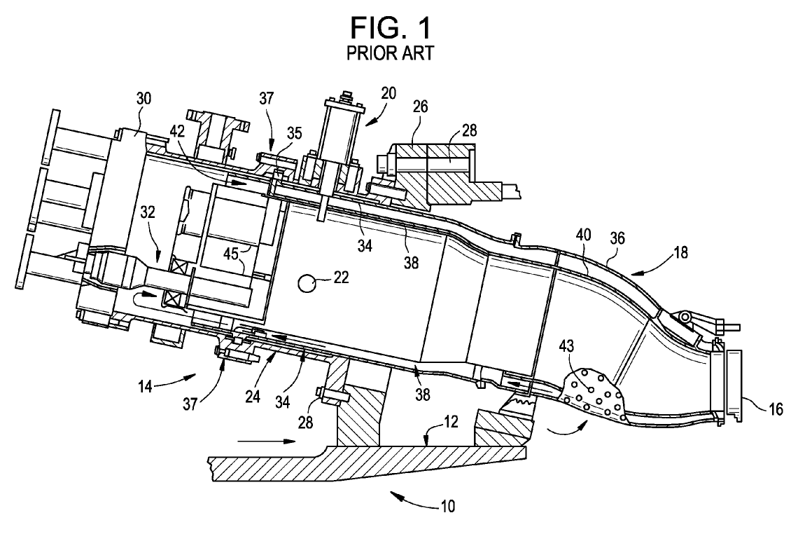

Referring to FIG. 1, a gas turbine 10 (partially shown) includes a compressor 12 (also partially shown), a plurality of combustors 14 (one shown), and a turbine section represented here by a single blade 16. Although not specifically shown, the turbine is drivingly connected to the compressor 12 along a common axis. The compressor 12 pressurizes inlet air which is then reverse flowed to the combustor 14 where it is used to cool the combustor and to provide air to the combustion process.

As noted above, a plurality of combustors 14 are located in an annular array about the axis of the gas turbine. A double-walled transition duct 18 connects the outlet end of each combustor with the inlet end of the turbine to deliver the hot products of combustion to the turbine. Ignition is achieved in the various combustors 14 by means of sparkplug 20 in conjunction with crossfire tubes 22 (one shown) in the usual manner.

Each combustor 14 includes a substantially cylindrical combustor casing 24 which is secured at an open forward end to the turbine casing 26 by means of bolts 28. The rearward or proximal end of the combustor casing is closed by an end cover assembly 30 which includes supply tubes, manifolds and associated valves for feeding gaseous fuel, liquid fuel, air and water to the combustor as described in greater detail below. The end cover assembly 30 receives a plurality (for example, three to six) “outer” fuel nozzle assemblies 32 (only one shown in FIG. 1 for purposes of convenience and clarity), arranged in a circular array about a longitudinal axis of the combustor, and one center nozzle. In some designs, the center nozzle is omitted.

Within the combustor casing 24, there is mounted, in substantially concentric relation thereto, a substantially cylindrical flow sleeve 34 which connects at its forward end to the outer wall 36 of the double walled transition duct 18. The flow sleeve 34 is connected at its rearward end by means of a radial flange 35 to the combustor casing 24 at a butt joint 37 where fore and aft sections of the combustor casing 24 are joined.

Within the flow sleeve 34, there is a concentrically arranged combustor liner 38 which is connected at its forward end with the inner wall 40 of the transition duct 18. The rearward end of the combustor liner 38 is supported by a combustor liner cap assembly 42 which is, in turn, supported within the combustor casing 24 by a plurality of struts and an associated mounting assembly (not shown in detail).

The outer wall 36 of the transition duct 18 may be provided with an array of apertures 43 to permit air to reverse flow from the compressor 12 through the apertures 43 and into the annular space between the flow sleeve 34 and combustor liner 38 toward the upstream end of the combustor (as indicated by the flow arrows in FIG. 1). This is a well known arrangement that needs no further discussion.

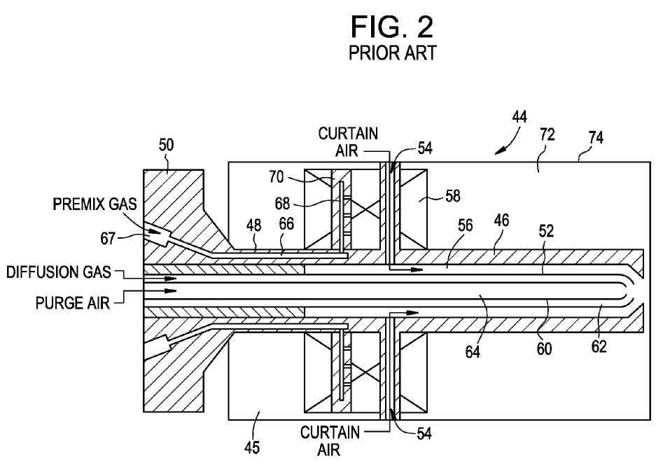

Turning to FIG. 2, a conventional gas-only nozzle 44 may be used in the group of radially outer nozzles surrounding the single center nozzle in accordance with an exemplary embodiment of this invention. The nozzle 44 includes a center body tube 46 that may be formed at a rearward end 48 with a flange 50 enabling attachment to an end cover assembly, as at 30 in FIG. 1. Alternatively, the flange 50 could be incorporated as part of the end cover assembly. It will be appreciated that the manner in which the various passages are provided in the nozzle, and the mounting arrangements for the various tubes within the nozzle are, for purposes of this invention, considered to be within the skill of the art. A first inner tube 52 is arranged concentrically within the outer tube 46, creating an annular curtain air supply (or first) passage 56, with a small quantity of compressor air entering the passage 56 through tube 46 via circumferentially arranged holes 54 in tube 46 and in the fixed vanes of swirler 58. The larger proportion of compressor air enters the premixer through an inlet section 45 and flows past the fixed vanes of swirler 58 and into the annulus 72 between burner tube 74 and outer tube 46, whereby swirl is imparted to the flow to promote mixing and flame stabilization.

A second radially inner tube 60 extends through the center of the nozzle, concentrically within the first radially inner tube 52. This arrangement creates an annular diffusion gas (or second) passage 62 between the first and second radially inner tubes. The diffusion gas is supplied through bosses/flanges and distributing tubes on the end cover assembly. The second radially inner tube (or center tube) 60 itself defines a purge air passage 64, with the air also supplied via hardware at the end cover assembly.

A premix (or third) radially inner passage 66 lies within the tube 46, the forward end of which terminates near the leading edge of fixed vanes of swirler 58. A second premix passage (not shown) may be formed radially between passages 56 and 66. Premix gas enters the nozzle through holes 67 in the flange 50 and exits through holes 68 in the sides of the vanes 70 into the annulus 72 of the burner tube 74 where it premixes and then enters the combustion zone. Diffusion gas and curtain air mix via holes (not shown) cross-drilled in the tip of tube 52.

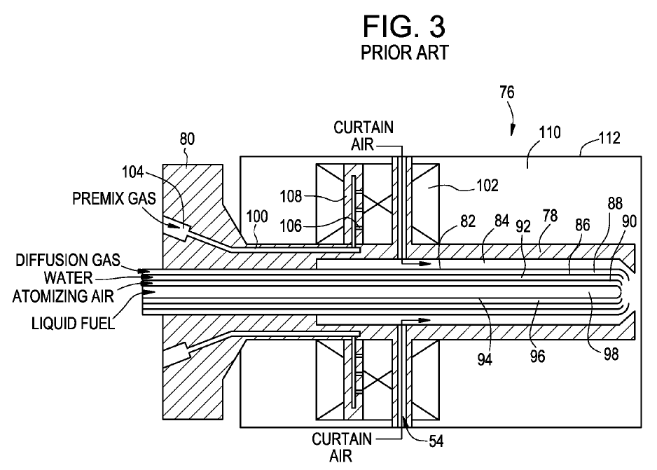

FIG. 3 illustrates a dual-fuel nozzle 76, also of known construction. The overall configuration of the nozzle may be generally similar to the nozzle shown in FIG. 2 but with additional passages that enable the nozzle to function as a dual-fuel nozzle. Thus, the nozzle 76 includes an outer tube 78 with a flange 80 at its rearward or upstream end that may be incorporated into an end cover assembly. A first inner tube 82, arranged concentrically within the outer tube 78 establishes an annular curtain air passage 84, with compressor air entering the passage in the same manner as described above in connection with the nozzle shown in FIG. 2.

A second inner tube 86, arranged concentrically within tube 82 creates an annular diffusion gas passage 88. A third inner tube 90 arranged concentrically within the tube 86 creates an annular water passage 92. A center tube 94 creates an annular atomizing air passage 96 while the center tube 94 itself serves as the liquid fuel passage 98. Here again, the various tubes are secured in an end cover assembly and are supplied with the appropriate fuel or other fluid (i.e., air or water) in an otherwise conventional fashion.

A premix gas passage 100 is formed within the tube 78 and terminates adjacent the swirler 102 (a second premix passage (not shown) may be provided between passages 84 and 100). As in the nozzle 44 shown in FIG. 2, the premix gas may be supplied through holes 104 in the flange (or end cover) 80 into the passage 100, to exit through holes 106 in the sides of vanes 108 into the annulus 110 of the burner tube 112.

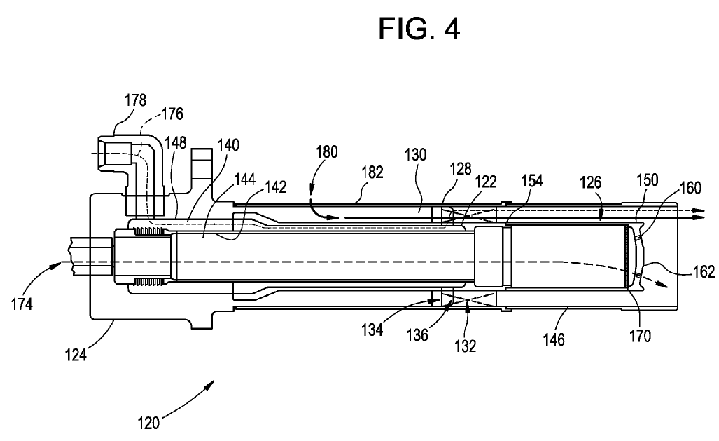

Turning to FIG. 4, a diffusion/premix fuel nozzle assembly 120 in accordance with this invention is shown which is intended to replace the nozzle assemblies shown in FIGS. 1-3. The nozzle assembly 120 includes a nozzle body 122 connected to a rearward supply section 124, and a forward fuel/air delivery section 126. The nozzle assembly includes a collar 128 which defines an annular passage 130 between the collar 128 and the nozzle body 122. Within this annular passage is an air swirler 132 (similar to swirler 58 in FIG. 2), containing a plurality of radial fuel passages 134, each of which is formed with a plurality of discharge orifices 136 for discharging premix gas into passage 130 within the premix region.

Premixed fuel gas indicated generally with flow line 176 is provided through a fitting 178 in fluid communication with passage 140. The premixed fuel gas passes through radial fuel passages 134 located inside swirl vanes 132 and then through orifices in the fuel vanes 136 where it mixes with air in passage 130. More specifically, combustion air indicated generally with flow line 180 passes through orifices in a tube 182 defining an outside wall of passage 130.

Still referring to FIG. 4, the nozzle body interior includes a centrally located (radially inner) tube 142 which feeds diffusion fuel or purge air to the combustion zone via internal passage 144. A radially outer passage 140 is defined between inner wall 148 of supply section 124 and tube 142, for carrying premix fuel gas to the premix zone as described above. Passage 140 continues into the annulus formed between the inner diameter of nozzle body 122 and the outer diameter of tube 142. The passage 140 is closed at its forward end, forcing the premix gas to exit the discharge orifices and into the premix zone 126 within premix tube 146 (equivalent to tube 45 in FIG. 1).

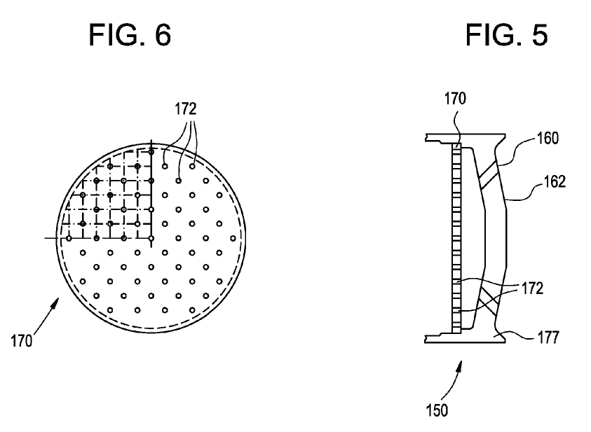

The nozzle tip 150 which incorporates the subject invention is best seen in FIGS. 4 and 5. The tip 150 is sized to engage the nozzle body 122 and to be welded or brazed thereto at 154 (see FIG. 4).

A plurality of discharge orifices or passages 160 extend through a forward wall 162 defining the tip and communicate with the diffusion gas passage 144. The orifices or passages 160 are angled as best seen in FIG. 5 to swirl the diffusion gas as it exits the nozzle body into the burning zone of the combustion chamber. The orientation of discharge orifices as shown in FIG. 5 is one embodiment, but other orientations are possible.

Referring now to FIGS. 4-6, an impingement baffle plate 170 having an array of small orifices 172 is disposed upstream or on a back side of the front wall 162 of the tip. Impingement baffle plate 170 is configured as a disc or a wall within gas passage 144.

In operation and referring again to FIG. 4, diffusion gas indicated generally with flow line 174 enters gas passage 144 via tube 142 and passes through orifices 172 of impingement baffle plate 170 and exit diffusion orifices 160 of the tip exiting the nozzle body into the burning zone of the combustion chamber. When the nozzle is flowing only premixed fuel, flow line 174 represents purge air going through this same passage.

With the tip welded or brazed to the nozzle body as shown in FIG. 4, it can be seen that the air and diffusion gas passages 130 and 144, respectively, are continued to the discharge end of the nozzle, with purge air or diffusion gas exiting the circular array of apertures 160, and premix gas forced to exit orifices 136 in the swirl vanes 132 as indicated with combined flow lines 176 and 180.

In an exemplary embodiment reflected in FIGS. 4-6, the tip of the diffusion nozzle is cooled via a combination of convection through the diffusion orifices 160, and impingement on the back side of the diffusion tip, promoted by the impingement baffle plate 170 having the array of small orifices 172 creating jets of diffusion fuel or air 174 impinging on the diffusion tip. Note that the design shown in FIG. 4 also eliminates the center cartridge in the fuel nozzle that is normally used for liquid fuel. It will be recognized by one skilled in the pertinent art that a similar design is contemplated with the center cartridge in place.

The impingement baffle plate 170 promotes effective cooling of the diffusion tip by high heat transfer coefficients imposed by the pressure drop of the fuel gas or air through the small orifices 172 in the baffle. Average HTCs on the order of about 400 to about 600 BTU/hr*ft2 *F are easily achieved by this technique, which is more than sufficient to provide adequate cooling of the diffusion tip. The additional pressure drop incurred for this impingement can be kept within acceptable levels for the turbine fuel supply system. Since the cooling is accomplished with the same fluid (e.g., purge air or diffusion gas) as is flowing through the diffusion orifices 160, there is no need for a costly additional flow path to the tip.

As a result, the incorporation of an impingement baffle plate 170 at the back side of the diffusion tip provides impingement cooling thereof when a fluid flows through an array of orifices 172 creating jets of fuel or air impinging on the diffusion tip. In this manner, the impingement baffle plate 170, in conjunction with preserving cooling via convection through the diffusion orifices 160, facilitates extending a useful life of the nozzles in a cost-effective and reliable manner. Preserving the existing method of cooling via convection through the diffusion orifices 160 allows the cooling to be more robust by this technique. Cooling can also be more concentrated at the outer radius of the tip, helping to cool an exposed corner 176 defining the tip that is most susceptible to thermal distress as best seen with reference to FIG. 5.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A method of cooling a gas fuel nozzle, the method comprising:
disposing an impingement baffle plate upstream of at least one fuel orifice defining a nozzle tip, said baffle plate having an array of small orifices; and
creating jets of cooling fluid impinging on said nozzle tip via said impingement baffle plate when at least one of fuel and air flow through said array of small orifices.

2. The method of claim 1, wherein the cooling fluid flowing through said array of small orifices is the same fluid flowing through said at least one fuel orifice into a combustor, thereby eliminating an additional flow path to the nozzle tip.

3. The method of claim 1, wherein cooling of the nozzle tip is a combination of impingement of the cooling fluid on the back side of the nozzle tip via the impingement baffle plate and convection through said at least one fuel orifice using same said cooling fluid.

4. The method of claim 1, further comprising:
disposing said array of small orifices scattered about one of a total surface area defining said baffle plate for a gas fuel nozzle tip and an outer periphery of a surface area defining said baffle plate in a dual fuel nozzle tip.

5. The method of claim 4, wherein said array of small orifices scattered about an outer periphery of a surface area defining said baffle plate in a dual fuel nozzle tip circumferentially surround a center cartridge used for liquid fuel.

6. The method of claim 1, further comprising:
configuring at least a portion of said array of small orifices to concentrate a greater proportion of said cooling fluid to an outer radius of the nozzle tip helping to cool exposed corners defining the nozzle tip.

7. The method of claim 1, wherein said impingement baffle plate promotes effective cooling of the nozzle tip by high heat transfer coefficients imposed by a pressure drop of said cooling fluid flowing through said small orifices.

8. The method of claim 7, wherein heat transfer coefficients on the order of about 400 to about 600 BTU/hr*Ft*F are achieved using said impingement baffle plate.

9. A method of cooling a fuel nozzle tip, the method comprising:
providing a gas fuel nozzle including an outer peripheral wall; an air flow passage defined within said outer wall and extending at least part circumferentially thereof; and a central gas fuel flow passage;
securing a nozzle tip to said outer peripheral wall at a distal end thereof to substantially block said central gas flow passage, said nozzle tip including at least one fuel orifice defined about a periphery thereof; and
disposing an impingement baffle plate upstream of said at least one fuel orifice defining said nozzle tip, said baffle plate having an array of small orifices creating jets of fluid impinging on a back side of said nozzle tip;
wherein cooling of said nozzle tip is accomplished with the same fluid flowing through said impingement baffle plate and said at least one fuel orifice eliminating an additional flow path to said nozzle tip.

10. The method of claim 9, wherein said cooling fluid is one of a fuel gas and compressor discharge air.

11. The method of claim 9, further comprising:
disposing a center cartridge for use with a liquid fuel in a center portion of said nozzle tip, wherein said array of small orifices are circumferentially disposed around said center cartridge.

12. A fuel nozzle for a gas turbine comprising:
a nozzle body terminating at a tip portion;
a nozzle tip defining said tip portion, said nozzle tip defined by a plurality of fuel orifices about a periphery thereof; and
an impingement baffle plate upstream of said fuel orifices, said baffle plate having an array of small orifices creating jets of cooling fluid impinging on a back side of said nozzle tip via said impingement baffle plate when at least one of fuel and air flow through said array of small orifices.

13. The nozzle of claim 12, wherein said cooling fluid flowing through said array of small orifices is the same fluid flowing through said fuel orifices into the combustor, thereby eliminating an additional flow path to the nozzle tip.

14. The nozzle of claim 12, wherein cooling of the nozzle tip is accomplished by a combination of impingement of said cooling fluid on a back side of said nozzle tip via said impingement baffle plate and convection through said fuel orifices using a same fluid flowing therethrough.

15. The nozzle of claim 12, wherein said array of small orifices are scattered about a total surface area defining the said baffle plate for a gas fuel nozzle tip.

16. The nozzle of claim 12, wherein said array of small orifices are scattered about an outer periphery of a surface area defining said baffle plate in a dual fuel nozzle tip.

17. The nozzle of claim 16, wherein said array of small orifices scattered about an outer periphery of a surface area defining said baffle plate in a dual fuel nozzle tip circumferentially surround a center cartridge used for liquid fuel.

18. The nozzle of claim 12, wherein at least a portion of said array of small orifices are configured to concentrate a greater proportion of said cooling fluid to an outer radius of said nozzle tip helping to cool exposed corners defining said nozzle tip.

19. The nozzle of claim 12, wherein said impingement baffle plate promotes effective cooling of the nozzle tip by high heat transfer coefficients imposed by a pressure drop of said cooling fluid flowing through said small orifices.

20. The nozzle of claim 12, wherein said nozzle tip is receptive to at least one of a diffusion mode and a premix mode of fuel-air mixing.
